(19) United States
(12) Patent Application Publication
(10) Pub. No.: US 2014/0074655 A1
(43) Pub. Date: Mar. 13, 2014

(54) SYSTEM, APPARATUS AND METHODS FOR ONLINE ONE-TAP ACCOUNT ADDITION AND CHECKOUT

(71) Applicants: David Lim, New York, NY (US); Greg Williamson, Mount Kisco, NY (US)

(72) Inventors: David Lim, New York, NY (US); Greg Williamson, Mount Kisco, NY (US)

(21) Appl. No.: 13/606,295

(22) Filed: Sep. 7, 2012

(51) Int. Cl. G06Q 40/00; H04B 5/00; G06Q 30/00

(52) U.S. Cl. 705/26.35; 705/41; 705/26.1

(57) ABSTRACT

Disclosed are methods, computer readable media and apparatus for providing one-tap account addition and one-tap checkout features to a consumer. In an embodiment, a wallet server computer receives a request from a consumer device to enable a one-tap account addition feature, and receives consumer registration data and consumer payment account data. The wallet server then uploads consumer device data and reader device data, and determines that the reader device is near-field communication capable. The wallet server next stores the consumer registration data, payment account data, and the consumer device data in an electronic wallet and enables the one-tap add account addition feature. In some embodiments, the consumer may select to opt-in to a one-tap checkout feature, and if so then a one-tap checkout cookie is transmitted for storing on the consumer device.

### BACKGROUND

Proximity payment cards (or contactless payment cards) have been developed that allow a consumer's payment account number to be automatically read from the proximity card by radio frequency communication with a “proximity reader” that is typically associated with or incorporated into a point-of-sale (POS) terminal at a merchant retail store. Proximity payment cards typically include a radio frequency identification (RFID) integrated circuit (IC), often referred to as a “chip”, that is embedded within the card body. A suitable antenna is also typically embedded in the card body and is connected to the RFID IC to allow the chip to receive and to transmit data by radio frequency (RF) communication via the antenna. For example, an interrogation signal transmitted by the proximity reader of the POS terminal is received by the antenna within the proximity payment card and used to power up the RFID IC of to initiate a purchase transaction.

MasterCard International Incorporated, the assignee hereof, has established a widely-used standard, known as PayPass®, for interoperability of contactless payment cards and proximity readers. In addition, other types of wireless protocols for the wireless exchange of information have been established, such as Near-Field Communication (NFC), for payment applications.

The capabilities of a proximity payment card (or a contactless payment card) have recently been incorporated into portable or mobile devices, thereby turning such mobile devices into contactless payment devices. Such a contactless payment device typically includes integrated circuitry with the same or similar functionality as the RFID IC of a contactless payment card. The mobile device and/or contactless payment device also conventionally includes a loop antenna that is coupled to the payment-related IC for use in sending and/or receiving messages in connection with a transaction that involves contactless payment. Examples of payment-enabled mobile devices include, but are not limited to, mobile telephones, key fobs, portable digital music players, personal digital assistants (PDAs) and the like.

The development of the Internet has changed the way in which consumers shop for and purchase products and services. For example, online shopping websites and/or merchants commonly discount prices and promote free-shipping or reduced fee shipping options, and thus more consumers are utilizing the Internet to shop and to conduct purchase transactions. In fact, many Internet-connected consumers research products, conduct product searches, compare prices and purchase merchandise online without leaving the comfort of their homes. Consumers may also feel safe shopping online due to the development of improved secure online payment technology, which has made consumers feel more comfortable about using credit card accounts, debit card accounts, pre-paid accounts and/or other types of financial accounts to make purchases over the Internet.

However, some deterrents to online shopping remain. In particular, some consumers find website checkout procedures to be inconvenient, tedious and time-consuming. For example, when a consumer wishes to use a new payment card account at a merchant's online store, typically the merchant requires the consumer to manually enter the new financial account data, which process is prone to data input errors. Consumers become annoyed when mistakes are made concerning the input of their personal and/or financial information and thus may avoid online shopping which results in lost revenues for merchants.

Thus, a need exists for systems, apparatus and processes to facilitate a secure and convenient online shopping experience, which allows consumers to quickly, accurately and efficiently add one or more proximity payment device accounts to an electronic wallet. A need also exists for systems, apparatus and processes that permit consumers to quickly and easily checkout when making online purchases without the need to manually enter payment card account and/or financial account data.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a block diagram of an embodiment of a proximity payment circuit suitable for use with processes according to embodiments of the invention;

FIG. 2 is a block diagram illustrating certain aspects of software that may include one or more application programs configured to control the proximity payment circuit of FIG. 1;

FIG. 3 is a block diagram illustrating a one-tap payment card addition and checkout system according to an embodiment of the invention;

FIG. 4 is a flowchart illustrating a consumer registration process for the one-tap account addition and checkout service according to an embodiment of the invention;

FIG. 5 is a flowchart illustrating an “add a card” process according to an embodiment of the invention;

FIGS. 6A to 6C are screen shots illustrating a “Tap-to-Add” payment account process for a consumer according to an embodiment of the invention;

FIG. 7 is a flowchart illustrating a “one-tap checkout” process according to an embodiment of the invention;

FIGS. 8A to 8C are screen shots illustrating an “Express Checkout” (one-tap checkout) process for a consumer according to an embodiment of the invention; and

FIG. 9 is a block diagram of an embodiment of a wallet server computer according to an embodiment of the invention.

### DETAILED DESCRIPTION

In general, and for the purpose of introducing concepts of novel embodiments described herein, provided are systems, apparatus and methods for providing a one-tap account addition and a one-tap checkout service for consumers. One-tap account addition permits the consumer to quickly and easily add a financial account, such as a proximity payment card account, to his or her electronic wallet by tapping the proximity payment card on a proximity reader associated with his or her consumer device. In some embodiments, the proximity reader transmits the financial data associated with that proximity payment card to a wallet server computer which stores the added financial account information in a database.

The one-tap checkout feature permits a consumer to quickly and accurately checkout from an online merchant website. In some implementations, when the consumer registers for the one-tap account addition service (to enable the one-tap “Add a Card” feature), or when the consumer later adds a proximity payment account, he or she may be prompted to opt-in to a one-tap checkout feature for use when online shopping. If the consumer opts-in, then during checkout from a merchant's website the consumer may select the one-tap checkout option and be prompted to tap his or her proximity payment device on the proximity reader associated with his or her consumer device. When the tap is made, the proximity reader reads data from the proximity payment device and transmits that data to the wallet server which authenticates the consumer. The wallet server then transmits consumer data to the merchant's website which is utilized to automatically populate the checkout webpage with required financial data and/or shipping information. In some implementations, a consumer may associate one-tap checkout with one or more of the payment accounts stored in the consumer's mobile wallet. Thus, the one-tap checkout feature enables the consumer to quickly and easily provide checkout data to a merchant's website by tapping his or her proximity payment device on a proximity reader in accordance with the methods presented herein.

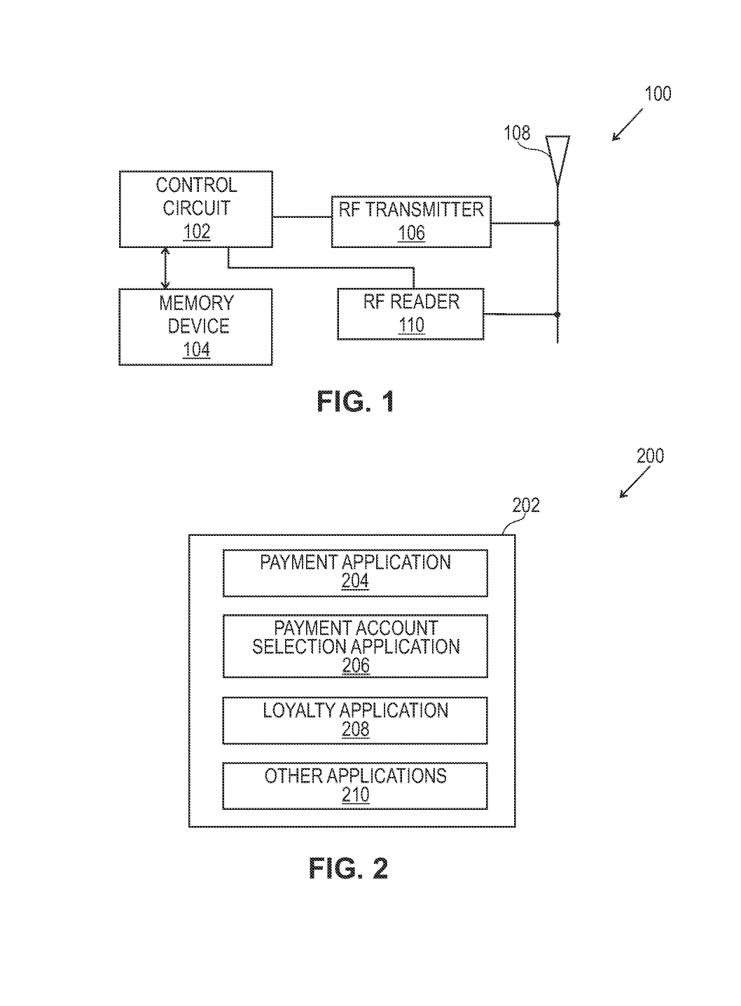

FIG. 1 is a block diagram of an embodiment of a proximity payment circuit 100 which may be found in a proximity payment card and/or may be suitable for use in a consumer's mobile device such as a mobile telephone, key fob and the like. The payment circuit 100 includes a control circuit 102 which may be a microprocessor or microcontroller (or a circuit with similar functionality). In some implementations, the control circuit 102 may be integrated with a main processor of a consumer's mobile device, for example the main processor of a mobile telephone, or may be configured to communicate with such a main processor. The control circuit 102 is configured to communicate with a memory device 104 that may comprise one or more different storage devices, and may overlap with a memory device (not shown) of a mobile device. The memory device 104 is configured to store one or more applications that include program instructions that control the operation of the control circuit 102 and that cause a proximity payment device to operate in accordance with one or more of the processes described herein. Also included is an RF transmitter 106 coupled to an antenna 108 and to the control circuit 102. The RF transmitter 106, under the control of the control circuit 102, may operate in a conventional manner. For example, the RF transmitter 106 may respond to interrogation signals (received from an external RF reader, not shown) by transmitting a payment account number and/or other identifying data and/or information to the RF reader. The RF transmitter 106 may operate in accordance with one or more conventional Radio Frequency Identification (RFID) standards, such as the above-mentioned PayPass® standard and/or Near-Field Communication (NFC) standard.

In addition, the payment circuit 100 may include an RF reader 110 that is coupled to the antenna 108 and to the control circuit 102. The RF reader 110, also under the control of the control circuit 102, may operate in accordance with conventional principles so that, for example, an interrogation signal is transmitted at regular intervals via the antenna 100. The RF reader may then listen for a possible response signal and/or message from a nearby RFID tag (not shown). The RF reader 110 may also operate in accordance with one or more conventional standards for short distance RF communication, such as the PayPass® standard and/or NFC standard.

FIG. 2 is a block diagram 200 that illustrates certain aspects of software that may include one or more application programs, and that may be stored in the memory 104 of the payment circuit 100 of FIG. 1 and configured to control the payment circuit 100. Constituent elements of an electronic wallet function 202 are shown that may have been downloaded, for example, from a wallet server (which will be described below) and stored in a memory for implementation by a consumer's proximity payment device (such as a proximity payment card, or a payment-enabled mobile telephone, or key fob and the like). In general, an electronic wallet obtains and stores a consumer's payment account data and/or other credentials for use to carry out financial transactions, for example, to purchase products from online merchants and/or from retail stores.

Referring again to FIG. 2, block 204 represents a payment application program that allows the user (consumer) to store and manage payment account information in his or her proximity payment device, for example a mobile telephone, and that enables the proximity payment device to function as a contactless transaction device or proximity payment device. Therefore, in some embodiments, the payment application program 204 is configured to store a plurality of consumer or user financial account information (such as one or more payment card account numbers and associated data that correspond to, for example, credit card accounts, debit card accounts, pre-paid card accounts and the like), and is configured to provide the functionality required for the mobile device to be used as a contactless transaction device. Block 206 represents a payment account selector application that permits a consumer to choose, for example, a particular payment card account from a plurality of payment card accounts available from the electronic wallet for use in any particular transaction. The payment card account selector 206 may also provide options to the consumer that permits the consumer to select criteria and/or conditions for any particular payment card account. For example, in some embodiments, a consumer can specify that a “rewards” payment card account is to be automatically selected (or be the default payment account) for a particular type of payment transaction, and specify one or more conditions or criteria that must occur. For example, the “rewards” payment card account is automatically selected when a purchase transaction involves a particular online merchant, and/or if it involves a minimum or maximum monetary amount for that particular transaction, and/or if it occurs at a particular time of day. Other types of conditions and/or criteria may be utilized.

Also depicted in FIG. 2 is a loyalty application 208 may also be included in the mobile wallet 202, and the loyalty application may allow the consumer to store and manage customer loyalty and/or rewards card accounts that include loyalty identification credentials (e.g., identification and/or loyalty account numbers) associated with retailers and/or service providers. For example, the loyalty application 208 may allow the consumer's payment-enabled mobile telephone (not shown) to also function as a contactless identification token by, for example, tapping his or her mobile telephone on a proximity reader device associated with his or her consumer device which then transmits a loyalty program identification number from the electronic wallet to a merchant's website. The merchant may then operate to credit and/or debit a loyalty account associated with the consumer, which may depend upon certain merchant or loyalty criteria and/or conditions such as whether or not the consumer has made an eligible purchase to obtain loyalty points (in some implementations such criteria may be predetermined by a merchant). In some cases, the consumer may be eligible for a discount because a certain amount of loyalty points (a threshold level) has been achieved, which in some embodiments may result in, for example, the merchant awarding a discount or rebate at the time of the purchase transaction.

In addition, the electronic wallet function 202 may include other applications 210 that may be stored in the memory 104 of the payment circuit 100 depicted in FIG. 1. Such other applications may, for example, control and/or provide functionality associated with the payment circuit 100 and/or may include additional functions that are not illustrated in FIG. 2. It should also be understood, however, that an electronic wallet function may, in some embodiments, lack one or more of the application programs depicted in FIG. 2.

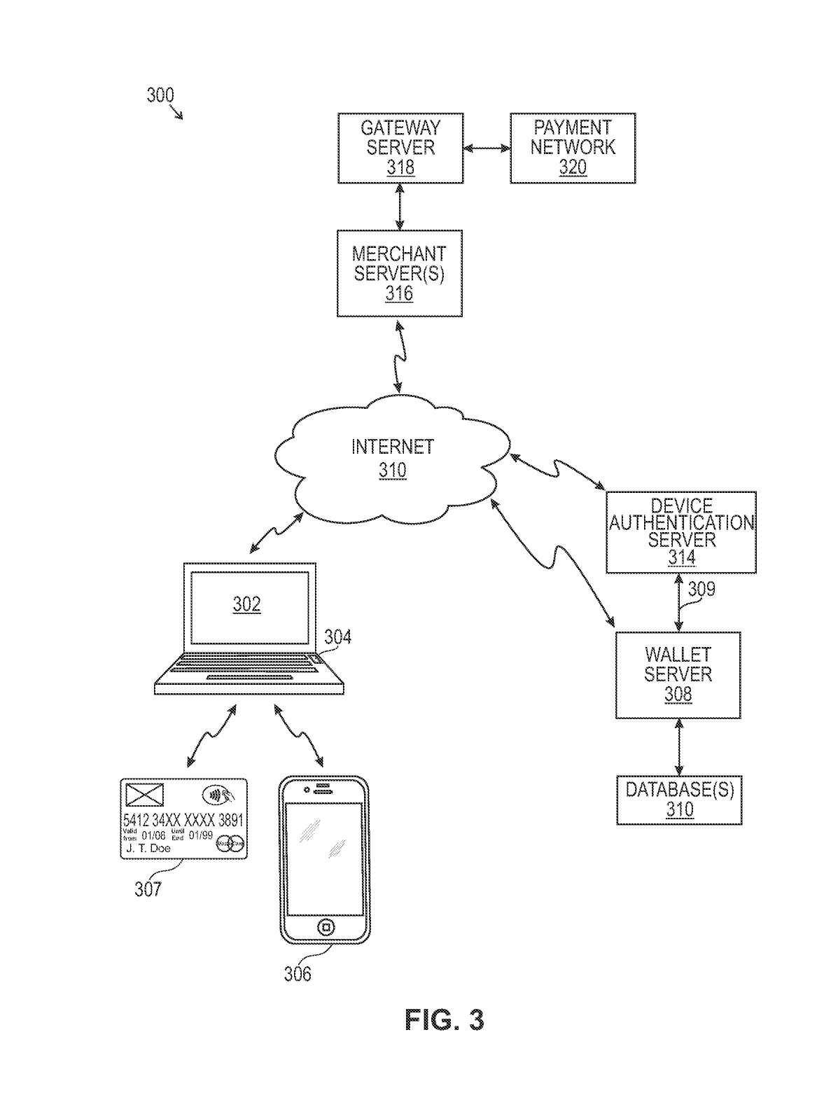

FIG. 3 is a block diagram illustrating a one-tap payment card addition and checkout system 300 according to an embodiment. The system 300 may be used to initiate and complete Internet-based transactions in accordance with processes described herein. A consumer device 302, which may be a laptop computer, desktop computer, tablet computer (such as an iPad™) and the like, is wirelessly connected (or connected via cables, such as fiber-optic cable) to the Internet 310, and includes a reader device 304. The reader device 304 is configured to read the payment credentials of, for example, a payment enabled mobile device 306 or a payment card 307 via a chip, PayPass™, NFC, bluetooth, or infrared (IR) protocol. In some embodiments, the reader device 304 is integrated with the consumer device 302 such that one or more chipsets and/or other components are housed within and/or incorporated into the consumer device. But in other implementations, the reader device 304 is a separate peripheral component that is operably connected to, and associated with, the consumer device 302. For example, the reader device may be connected to the consumer device via, for example, a USB cable or via a wireless connection. In either case, the reader device 304 provides the consumer device 302 with near-field communications (NFC) capability for reading a consumer's proximity payment device 306 and/or proximity payment card 307. The proximity payment device 306 may be a portable digital device, such as a mobile telephone containing a payment circuit (such as the payment circuit 100 depicted in FIG. 1), or some other device such as a key fob, digital music player, personal digital assistant (PDA) and the like.

Referring again to FIG. 3, the consumer device 302 is also configured for communicating via the Internet 310 with various other computing devices (such as server computers) to obtain access, for example, to merchant websites and to a one-tap payment card addition and checkout service website, which will be discussed below. The system 300 also includes a wallet server 308 that may be connected to one or more database(s) 310, and may be configured for secure communication via a dedicated communications channel 309 with a device authentication server computer 314. In some embodiments, the device authentication server 314 may be designed and operated by a third party provider, such as the SecureKey Technologies Incorporated company of Toronto, Canada, and may function to authenticate consumer devices. Also depicted are merchant servers 316 which are operably connected to the Internet 310. The merchant servers may be connected via a private network (not shown) to a gateway server 318, which is operably connected to a payment network 320. The wallet server computer 308, device authentication server computer 314 and merchant server computers 316 are all configured for communications via the Internet 310 with each other (and may also be configured for communication with other devices). The merchant server computers 316 may function to provide access to consumers to various shopping websites, and may also be configured to obtain payment transaction credentials and forward them for processing via the gateway server 318 to the payment network 320. It should be understood that a plurality of merchant servers 316 can be connected via the Internet to the gateway server 318 and payment network 320. In addition, other network configurations may be utilized that, for example, include a plurality of gateway servers, payment networks and/or wallet servers that are capable of operating in accordance with processes described herein.

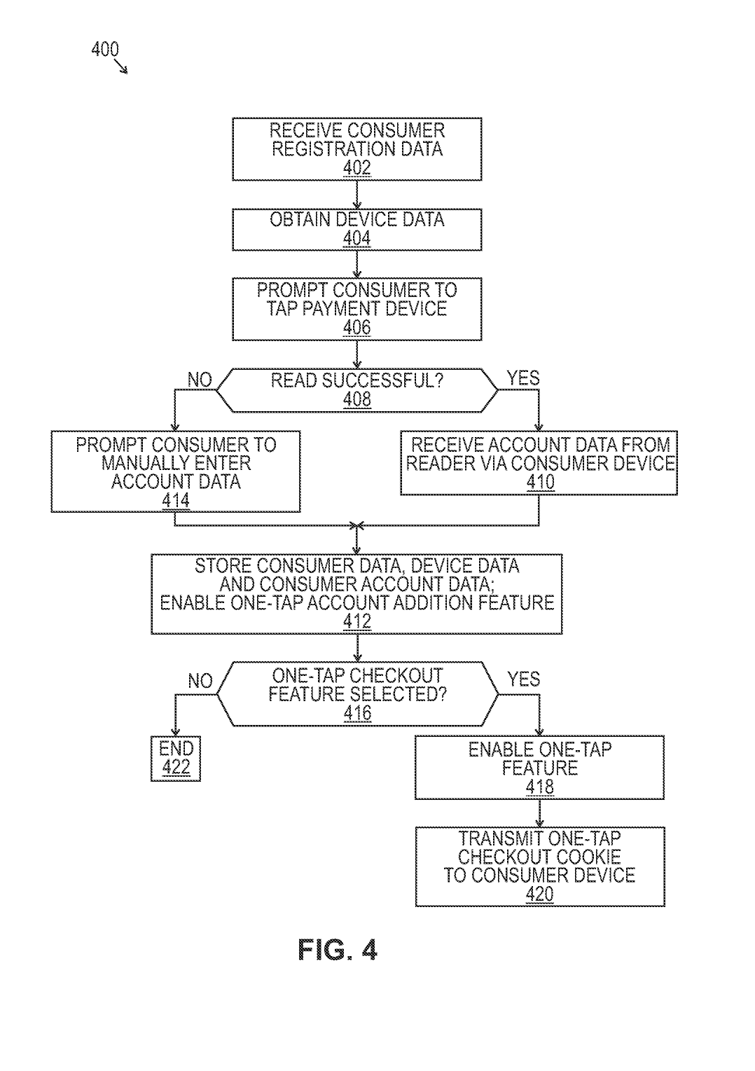

FIG. 4 is a flowchart illustrating a consumer (or customer) registration process 400 for the one-tap account addition and checkout service according to an embodiment. In some implementations, the consumer uses his or her consumer device 302 to register for a one-tap account addition feature by accessing a wallet server website and providing consumer registration data and device data, to thereby register for a one-tap account addition and checkout service. In some embodiments, the consumer utilizes his or her consumer device 302 to navigate via the Internet 310 to a one-tap account addition and checkout registration webpage (not shown) provided by the wallet server 308. If it is the first time that the consumer is visiting the registration webpage, then the consumer sets-up an account and provides consumer registration data by filling in the data input fields that are provided with required information. Thus, the wallet server 308 receives 402 consumer registration data, which may include consumer identification data such as the consumer's name, e-mail address, billing address, mobile telephone number and the like.

The wallet server 308 also obtains or uploads 404 device data, which may include consumer device 302 identification data such as a model number and/or serial number (or other consumer device identifier). In some embodiments, the consumer device data is automatically uploaded and entered by the wallet server during the registration process. In some implementations, the wallet server may also obtain proximity reader device data indicating that the proximity reader device is NFC capable. In addition, in some embodiments the proximity reader device data may include proximity reader identification data such as a serial number, model number, and/or other type of identifier of the reader device 304 that is associated with the consumer device 302. As mentioned above, the reader device 304 may be integrated with the consumer device 302 (thus, it may be housed within the same housing or otherwise be physically connected to or affixed to the consumer device), or may be a peripheral device that is operably connected to the consumer device. Furthermore, in some embodiments the consumer device may have an associated unique internet protocol (IP) address (which may be assigned by the consumer's Internet service provider, for example) that could be used as an indication of the location (for example, a residence address or business address) of the consumer's device and/or origin of a purchase transaction request. Accordingly, the IP address of the consumer device may also be acquired as device data during the consumer registration process for use as another data point during a purchase transaction to increase security. Such operation is advantageous from a security standpoint because it is relatively easy to obtain and utilize a consumer device serial number and/or an IP address, and the use of such identifiers is transparent to the consumer. Such operation may serve to increase the confidence level from the viewpoint of a payment account issuer (for example, and issuer financial institution such as a bank that issued the payment card account to the consumer) and/or from the viewpoint of an acquirer financial institution (for example, an acquirer bank associated with the merchant) that a particular online purchase transaction was initiated by the consumer associated with a particular Internet-connected consumer device and associated with that payment account.

It is also contemplated that, in some embodiments, the wallet server 308 may communicate with payment card issuer server computers (not shown in FIG. 3) to authenticate consumer identities via account provisioning checking. In addition or alternately, the wallet server 308 may be configured to communicate with one or more authentication device servers 314 to authenticate consumer identities via account provisioning checking.

Referring again to the consumer registration process of FIG. 4, the wallet server 308 prompts 406 the consumer to tap his or her payment device on the reader device, and if information from the payment device is read 408 successfully, then the wallet server receives 410 the consumer's payment account data. In some embodiments, the payment account data includes a primary account number (or “PAN”) associated with the consumer's payment card account. A PAN is used herein to refer to a number of digits (or characters) which identify a payment account issued by an issuer financial institution to a consumer. For example, in some embodiments a payment account is a credit account which is issued by a financial institution pursuant to the MasterCard International Incorporated rules, and the PAN may be a twelve to nineteen-digit string that identifies both the issuer (which may be based on the first few digits of the string, for example, the first five to ten digits) and the payment account number at the issuer. The PAN is typically utilized to route and process transactions that involve the payment card and the payment card account. Those skilled in the art will appreciate that other primary account number schemes and formats may be used in conjunction with embodiments described herein. In some implementations, the consumer may enter a plurality of payment accounts (for example, by providing a plurality of PANs), wherein each payment account is associated with a separate proximity payment device, and wherein any one of the payment accounts could be accessed to purchase goods or services from a merchant.

However, if in step 408 the read was unsuccessful, then the wallet server prompts 414 the consumer to manually enter payment account data. In this case, the consumer may be required to enter information such as his or her name, residence address, e-mail address, mobile telephone number, a PAN, and shipping information. Once all of the required data has been provided, whether provided by manual input or automatically provided by tapping the payment device on the proximity reader device, the wallet server 308 then stores 412 the consumer data, consumer payment account data and device data, and enables the one-tap add account feature. The consumer data, consumer payment account data and device data may be stored in, for example, the database 309.

The wallet server then prompts 416 the consumer (who was able to successfully tap the payment device) regarding whether or not he or she wishes to opt-in his or her payment account(s) for the one-tap checkout service feature. If the consumer agrees to opt-in, then the wallet server enables 418 the one-tap checkout feature and transmits 420 a one-tap checkout cookie to the consumer's device for storage on the consumer device. The one-tap checkout cookie permits the consumer device to pre-load the one-tap checkout feature when the consumer next checks-out from a merchant website. In addition, in some embodiments the absence of a one-tap add account cookie permits a consumer who has logged-in with a new consumer device (by authenticating his or her identity), and who has previously registered for the one-tap account addition feature, to easily register or associate that new consumer device with his or her payment accounts for the one-tap account addition feature (and possibly for the one-tap checkout feature). But if in step 416 the consumer does not wish to opt-in concerning the one-tap checkout feature, then the process ends 422.

In some embodiments, merchants do not have to register with the wallet server 308 regarding the one-tap checkout service. In such implementations, merchants may receive orders during their checkout procedure via standard data entry (wherein a consumer manually enters payment account and billing data) or via one-tap checkout, wherein the consumer data is provided from the wallet server computer. In either case, the consumer checkout data appears identical to the merchant.

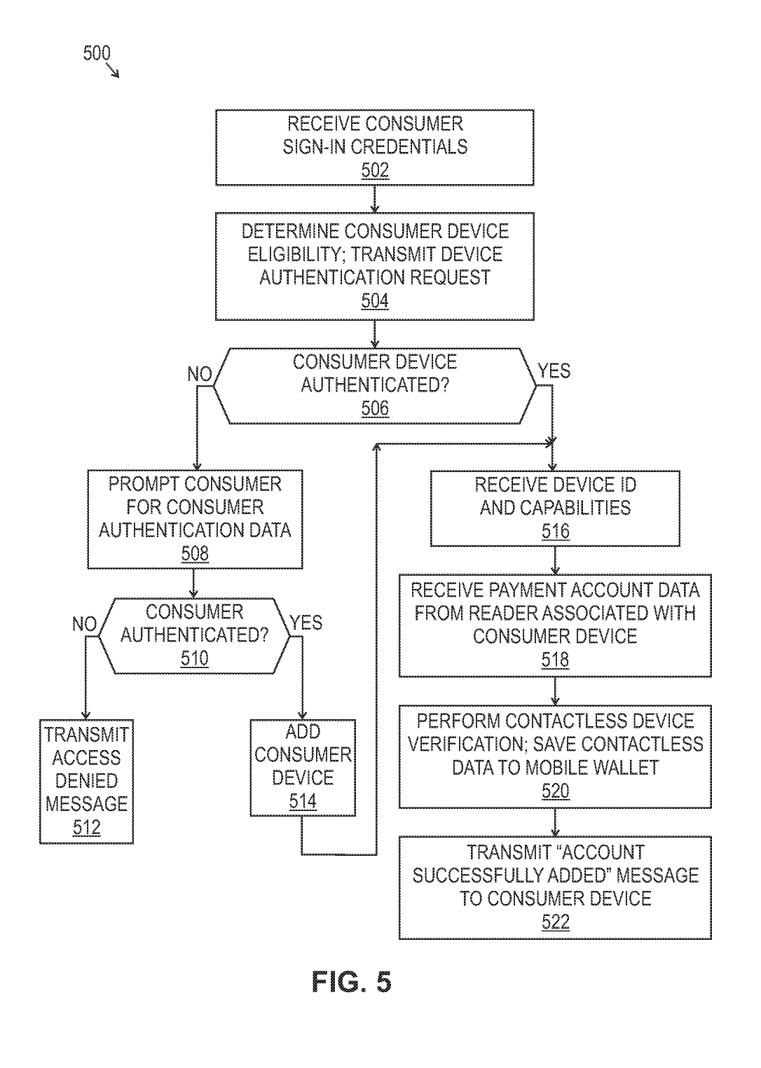

FIG. 5 is a flowchart illustrating an “add a card” process 500 for a registered consumer according to an embodiment. In some embodiments, the wallet server 308 receives 502 basic consumer sign-in data (such as a login ID and the like) from the registered consumer, determines consumer device eligibility and transmits 504 a device authentication request to the device authentication server computer 314. In some implementations, the device authentication server obtains device identification data from the consumer device and compares it to the consumer device registration data that was obtained during the consumer registration process discussed above. For example, the device authentication server may compare data from the consumer's device (and/or the IP address) to the consumer device identification data (such as the serial number and/or IP address) stored in the database 309 which was uploaded during the consumer registration process. If the consumer's device data does not match the stored device data, then the consumer is prompted 508 to provide their full consumer or customer authentication data. For example, in some embodiments the consumer is challenged to enter additional data such as a shared secret information (for example, the consumer may be challenged to enter his or her mother's maiden name or other such data) to authenticate his or her identity. In step 510, if the consumer is not authenticated then the wallet server transmits 512 an access denied message to the consumer device. But if in step 510 the consumer is authenticated, then the wallet server adds 514 the consumer device to a customer's device list of authorized consumer devices. Thus, each consumer or customer can be associated with multiple consumer devices and multiple payment accounts. In addition, in some implementations a particular consumer device can be associated with multiple consumers.

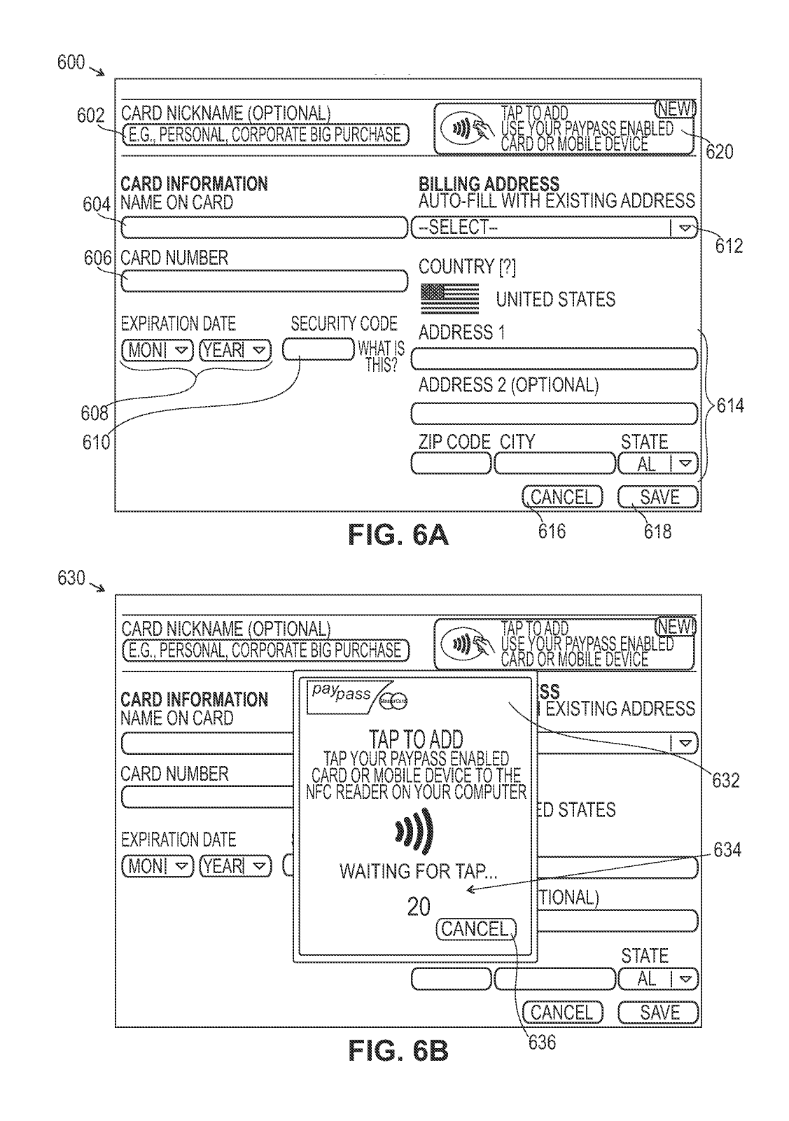

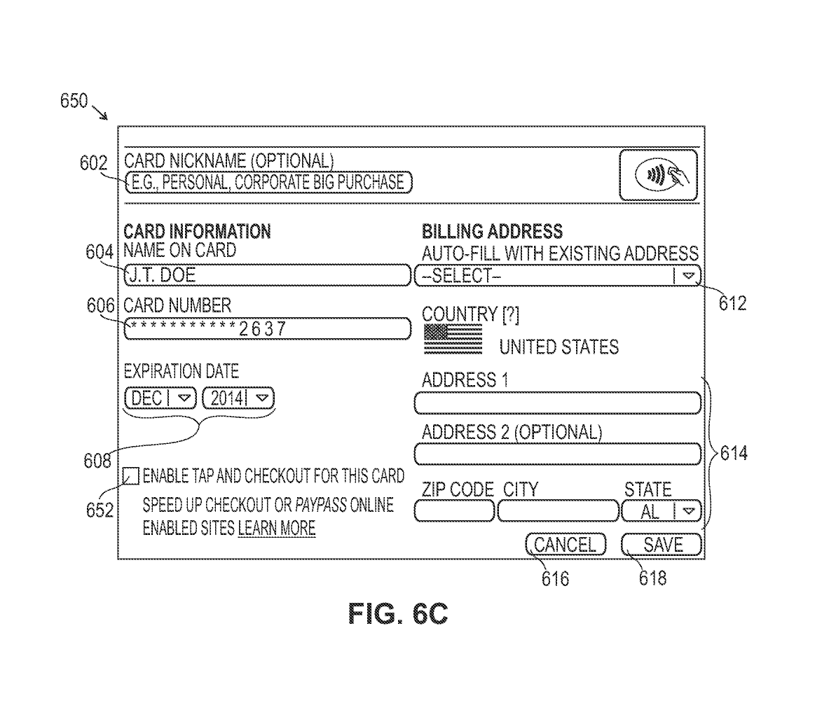

Referring again to FIG. 5, the wallet server then receives 516 a consumer device identifier and device capabilities (including near field communication (NFC) capability) of the consumer device. If the consumer device includes an associated proximity reader that is capable of reading a proximity device, then the user is presented with a webpage (discussed below with regard to FIG. 6A) that includes a “Tap to Add” payment device option that may be selected by the consumer. If the consumer selects this option, the device authentication server may push a tap request to the reader device associated with the consumer device, which then operates to prompt the consumer to tap his or her proximity payment device on the proximity reader. The proximity reader then reads a tap and transmits contactless payment account data via the consumer device to the wallet server website, and thus the wallet server next receives 518 the payment account data and performs 520 contactless device verification and then stores the data in the mobile wallet. In some embodiments, the wallet server may be configured for communicating with issuer financial institution server computers to authenticate contactless payment device credentials, for example the MasterCard™ contactless payment service may be utilized to authenticate PayPass™ payment card credentials. In some implementations, the wallet server then transmits 522 an “account successfully added” message to the consumer device.

In some embodiments, the wallet server website also presents, after processing the data for the “Add a Card” feature, an option for selection by the consumer regarding enabling (or opting-in to) a one-tap checkout feature. If the consumer opts-in to the one-tap checkout service, then one-tap checkout may be available from all merchant websites (or, in some implementations, may only be available from participating merchant websites that have registered to offer the one-tap checkout feature). As explained above, one-tap checkout allows consumers to tap their proximity payment device on the proximity reader so that all of the consumer's payment account data is automatically transmitted from the wallet server to the merchant's website and used to populate the merchant's checkout form, which facilitates and speeds checkout for the consumer from the participating merchant's website.

FIGS. 6A to 6C are screen shots illustrating a “Tap-to-Add” payment account process from the point of view of a consumer according to an embodiment. FIG. 6A is a screen shot of an “Add Card” webpage 600 presented to a consumer who has already registered his or her consumer device and proximity reader with the wallet server 308. The add card webpage 600 enables the consumer to add another proximity payment device (which may be a new payment account, for example) to his or her electronic wallet, and it includes a plurality of data entry fields. In this example, the data entry fields include a card nickname field 602, a name-on-card field 604, a card number field 606, expiration date fields 608, a security code field 610, a billing address field 612 and residence address fields 614. A “Cancel” button 616, “Save” button 618, and a “Tap to Add” icon 620 are also included. A consumer who has not registered his or her consumer device with the wallet server website is required to manually fill in the data fields 602, 604, 606, 608, 610, 612 and 614, and then selects the “Save” button 618 to add a proximity payment device to his or her mobile wallet. Such a manual process can be tedious and prone to data input errors.

However, a consumer who has registered his or her consumer device and proximity device for the one-tap add account feature can select the “Tap to Add” icon 620. After selecting the Tap to Add icon 620, the consumer is presented with the webpage 630 shown in FIG. 6B. In particular, FIG. 6B has a “Tap to Add” window 632 superimposed over the webpage 600 of FIG. 6A which prompts the consumer to “Tap your PayPass™ enabled card or mobile device to the NFC reader on your computer” and includes a countdown icon 634 showing, in this example, a twenty-second time frame in which the tap must be recorded by the proximity reader and data forwarded by the consumer device to the wallet server website or else the window will close. In some embodiments, the device authentication server 314 is notified that the consumer selected the Tap to Add icon 620 and functions to monitor the proximity reader for the tap by the consumer. A “Cancel” icon 636 is also provided in case the consumer wishes to forego the one-tap feature and instead manually enter the data.

If the consumer taps the proximity device that he or she wishes to add to the mobile wallet onto the proximity reader within the allotted time (i.e., before 20 seconds expires), then in some embodiments an indication is provided, such as an audible sound (beep) from the speaker of the consumer's device, that a good read has occurred. The consumer is then presented with the webpage 650 shown in FIG. 6C. In this example, as shown by the webpage 650, information has been automatically populated or filled in, based on the data read by the proximity reader and transmitted by the consumer device to the wallet server, for the data entry fields including the name on card field 604, card number field 606 and the expiration date fields 608. In some embodiments, the card data including the security code will be provided by the device authentication server upon proximity device authentication, and will be pre-populated in an un-editable manner and/or in a suppressed or inactive manner. In addition, in some implementations the card nickname field 602, billing address field 612, and residence address fields 614 must be manually filled in by the consumer. However, in other embodiments, these fields would also be automatically filled in based on information previously supplied by the consumer, or based on card account data read from the proximity payment card that is to be added to the mobile wallet.

Also shown in FIG. 6C is an “Enable Tap and Checkout for this card” checkbox 652, which may be utilized by the consumer to opt-in to that feature. As explained above, the one-tap checkout feature may be used to speed up checkout at a merchant's online shopping website.

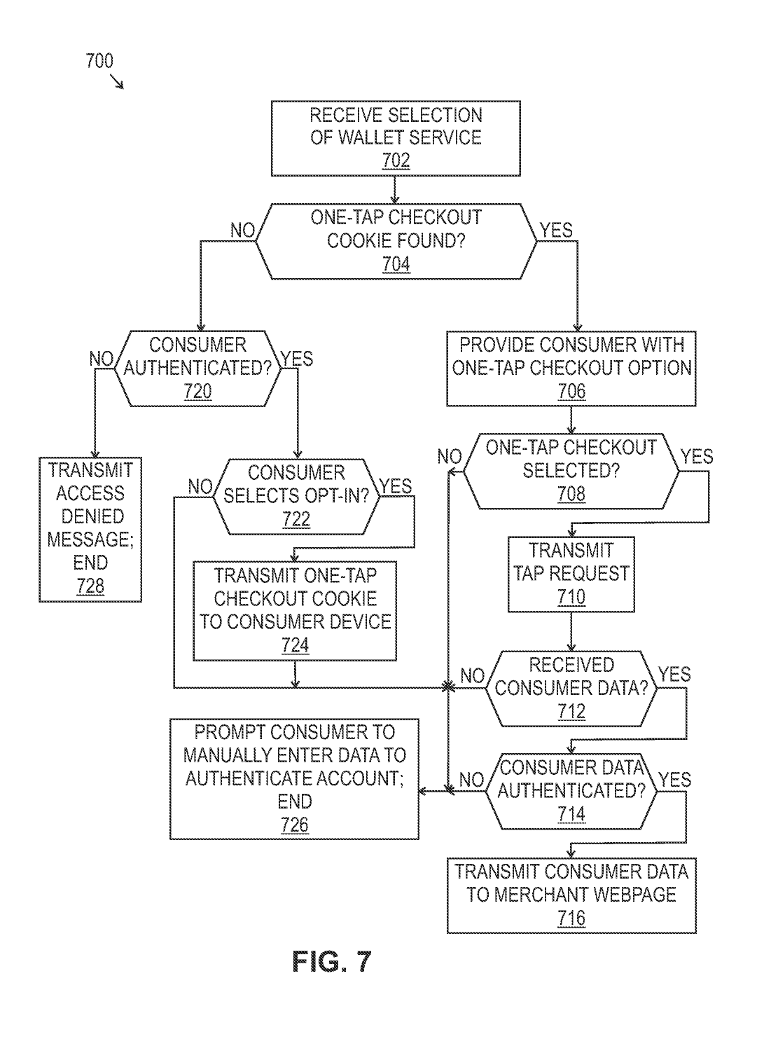

FIG. 7 is a flowchart illustrating a “one-tap checkout” process 700 according to an embodiment. In the example process 700, a consumer checks-out from a merchant's website by selecting 702 a wallet service such as the PayPass™ Wallet service. The wallet server then checks 704 for a one-tap checkout cookie on the consumer device. If the cookie is found then the wallet server provides 706 the consumer with a one-tap checkout option by, for example, providing a selection button that appears on a checkout data webpage (not shown). In step 708, if the consumer selects the one-tap checkout option by clicking on the selection button, then a tap request is transmitted 710 to the device authentication server 314. The device authentication server then prompts the consumer to tap their previously loaded contactless card on their proximity reader device. When the consumer taps his or her proximity payment device on the reader then the consumer's data is read and transmitted to the Wallet Server for authentication. For example, in some embodiments a PayPass™ Wallet Server computer receives 712 the consumer data and authenticates 714 the entirety of the request by checking, for example, to make sure that the consumer's device identifier is associated with the customer's account, that the payment card information matches the previously loaded payment card data for that consumer, that the consumer has opted-in to the One-Tap Checkout feature for that payment card account, and that the payment card account is in good standing (for example, the wallet server may utilized the Banknet Bridge™ service provided by MasterCard International Incorporated to re-authenticate the payment card account). If the consumer's data is authenticated then the wallet server transmits 716 the consumer's data including card account data and shipping address data to the merchant's website to automatically fill in that information on that merchant's checkout webpage during the checkout process.

Referring again to FIG. 7, if in step 708 the consumer does not select the one-tap checkout option (in some embodiments, after a predetermined amount of time expires), then the wallet server prompts 726 the consumer to manually authenticate their account to complete checkout, and the process ends. Similarly, if in step 712 the appropriate consumer information is not received within a predetermined time, or if in step 714 the consumer data is not authenticated, then the wallet server prompts 726 the consumer to manually authenticate their account to complete checkout, and the process ends.

Returning again to step 704 of FIG. 7, if a one-tap checkout cookie is not found then, in some embodiments the consumer is prompted 720 to manually authenticate their account by, for example, entering a username and password and the like. In some embodiments, if the consumer is authenticated 720 then the consumer is prompted 722 to opt-in for the one-tap checkout feature. If the consumer does opt-in, then the wallet server transmits 722 a one-tap checkout cookie to the consumer device for future use, and the consumer is prompted 726 to enter his or her checkout data manually and the process ends. If, in step 722 the consumer does not opt-in, then again the consumer is prompted 726 to enter his or her checkout data manually and the process ends. However, if in step 720 the consumer is not authenticated then the wallet server transmits 728 and “Access Denied” message to the consumer device and the process ends.

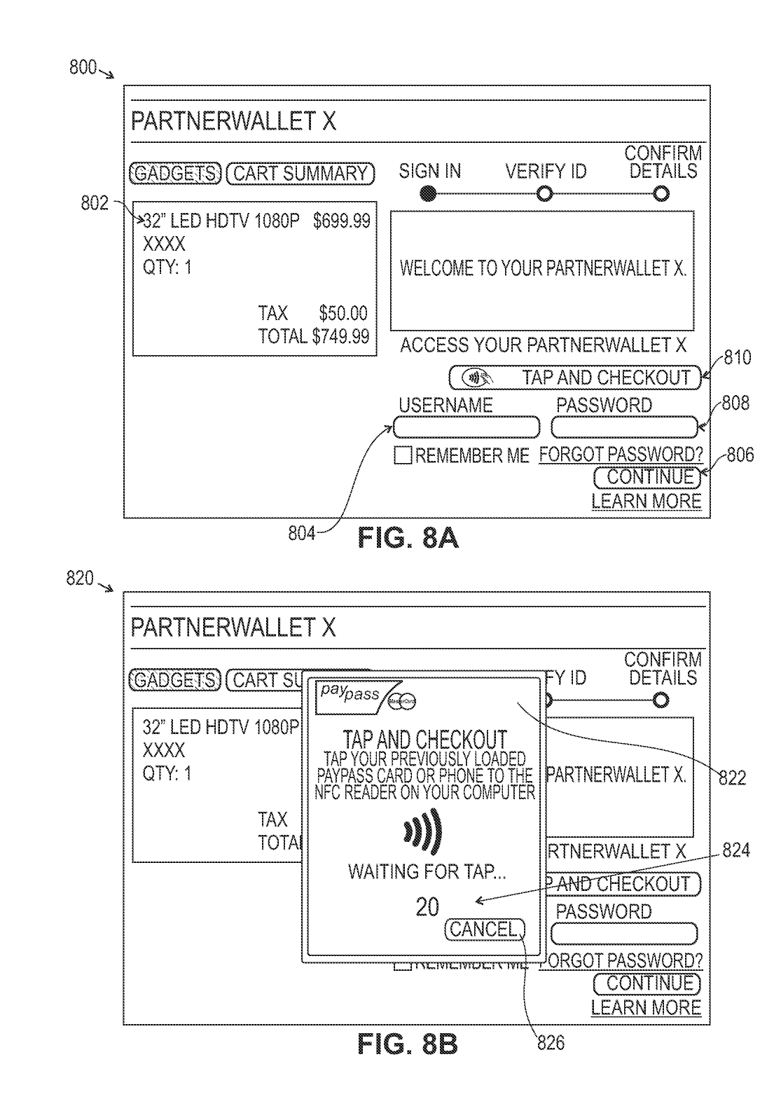

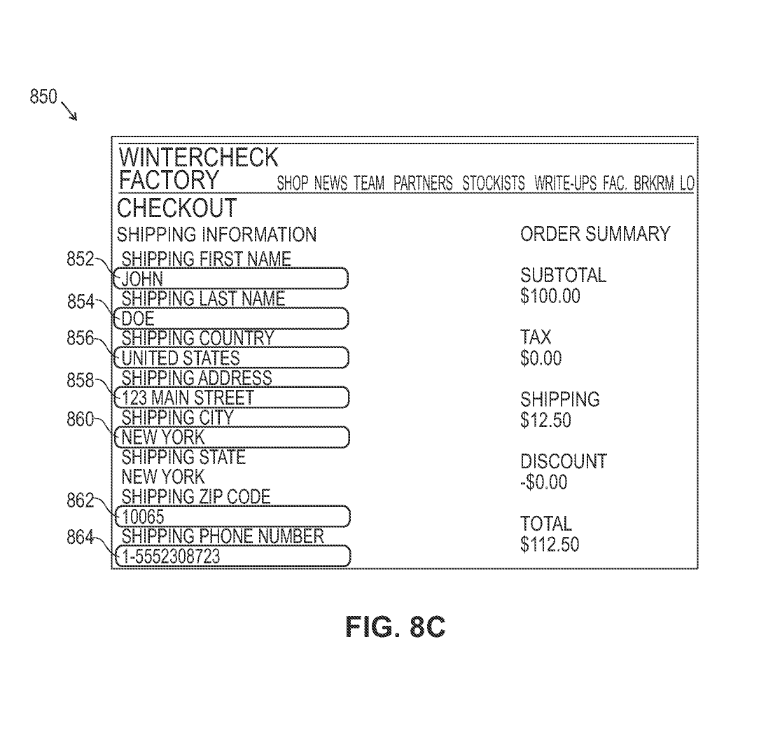

FIGS. 8A to 8C are screen shots illustrating an example “Express Checkout” (one-tap checkout) process from the point of view of a consumer according to an embodiment. In particular, FIG. 8A illustrates a PayPass™ checkout landing webpage 800, which appears after a consumer clicks on a “Pay with PayPass™ Online” selection button (not shown) on the merchant's checkout webpage. The PayPass™ checkout webpage 800 includes a cart summary section 802 that lists products and/or services chosen for purchase by the consumer, a Username field 804 and password field 806, a Continue button 808, and a “Tap and Checkout” button 810. The consumer may manually enter his or her username and password in fields 804 and 806 and click on the “Continue” button 808 to obtain another webpage for entry of further information (which process must be followed by consumers who have not registered for the one-tap checkout feature), or he or she may simply select the “Tap and Checkout” icon 810. Thus, a consumer who has registered his or her consumer device and proximity device for the one-tap checkout feature (as described above) can select the “Tap and Checkout” icon 810 to cause the webpage 820 shown in FIG. 8B to be presented. In some embodiments, a “cookie” is set when the consumer visits the PayPass™ website and uses (or does not use) the “one-tap checkout” feature so that when the customer returns to the merchant's website in the future, the Tap and Checkout button 810 is displayed (or is suppressed). In addition, in some implementations controls are provided for the merchant to suppress the Tap and Checkout button 810 if certain criteria are satisfied, for example, if a particular consumer resides in one of certain foreign countries, and the like.

FIG. 8B shows a “Tap and Checkout” window 822 superimposed over the PayPass™ checkout webpage 800 of FIG. 8A, which prompts the consumer to “Tap your previously loaded PayPass™ card or phone to the NFC reader on your computer”. The window 822 includes a countdown icon 824 showing, in this example, a twenty-second time frame (which may include a counter that counts down from twenty to zero, for example) in which the tap must be recorded by the proximity reader and data forwarded by the consumer device to the wallet server website, or else the window will close. In some embodiments, the Device Authentication server 314 is notified that the consumer selected the Tap to Checkout icon 810 and functions to activate the proximity reader and listen for the tap by the consumer. A “Cancel” icon 826 is also provided in case the consumer wishes to forego the one-tap checkout feature and instead manually enter required data.

If the consumer taps the proximity device onto the proximity reader within the allotted time (i.e., before 20 seconds expires), then in some embodiments an indication is provided to the consumer, such as an audible sound (beep) from the speaker of the consumer's device, that a good read has occurred. The consumer is then presented with the webpage that includes all of the checkout data pre-filled so that the consumer can quickly verify that information and then checkout (pay for the purchase transaction). For example, FIG. 8C is a screen shot of a Checkout webpage of a merchant called “Wintercheck Factory”, showing the results of a successful one-tap checkout process. In particular, fields for a shipping first name 852, shipping last name 854, shipping country 856, shipping address 858, shipping city 860, shipping zip code 862 and shipping phone number 864 have been automatically populated after the consumer has tapped his or her proximity payment device on the proximity reader. Thus, the consumer did not have to manually enter any login credentials (such as a UserID and/or password), and did not have to manually select their payment card account and shipping address on a wallet server website.

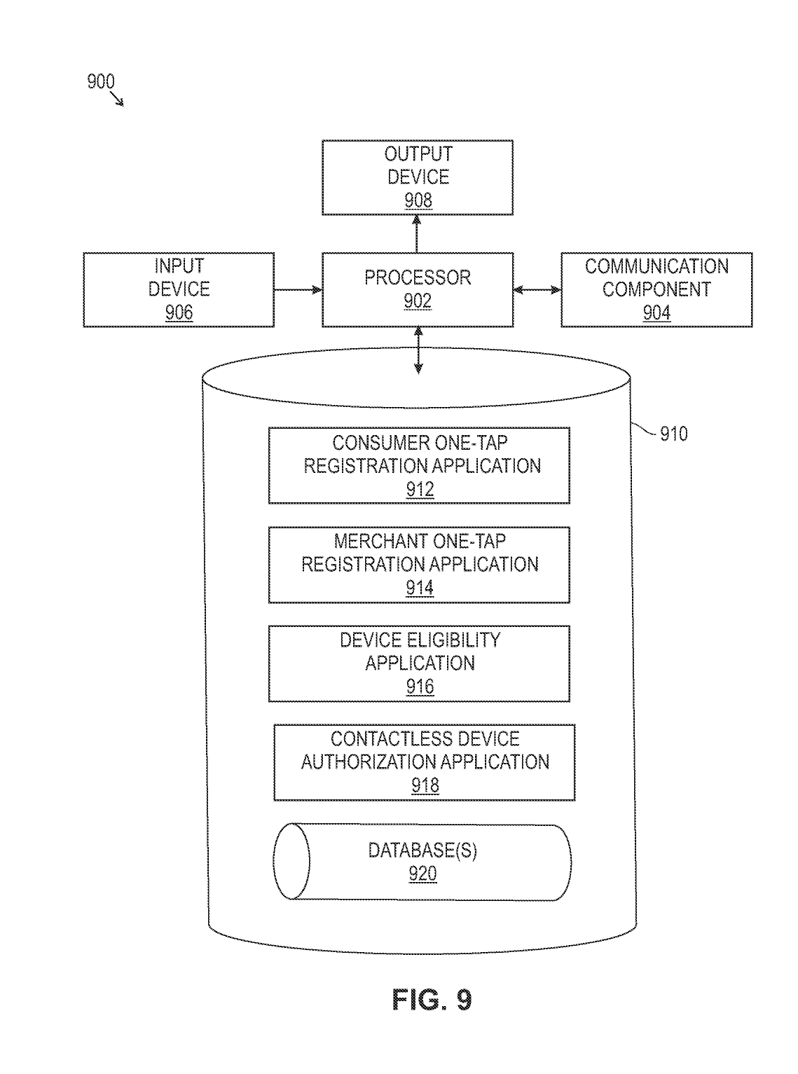

FIG. 9 is a block diagram of an embodiment of a wallet server computer 900. The wallet server computer 900 may be conventional in its hardware aspects but may be controlled by software to cause it to operate in accordance with aspects of the methods presented herein. In particular, the wallet server computer 900 may include a computer processor 902 operatively coupled to a communication component 904, an input device 906, an output device 908, and a storage device 910.

The computer processor 902 may constitute one or more conventional processors. Processor 902 operates to execute processor-executable steps, contained in program instructions described herein, so as to control the wallet server computer 900 to provide desired functionality.

Communication device 904 may be used to facilitate communication with, for example, other devices and/or server computers (such as for receiving data via the Internet from a consumer device and/or from a proximity reader and for transmitting data to the consumer device). Communication device 904 may also, for example, have capabilities for engaging in data communications over conventional computer-to-computer data networks, in a wired or wireless manner. Such data communications may be in digital form and/or in analog form.

Input device 906 may comprise one or more of any type of peripheral device typically used to input data into a computer. For example, the input device 906 may include a keyboard and a mouse and/or a touchpad that may be used, for example, by a systems engineer or other personnel authorized to, for example, perform server computer system maintenance or other task. The output device 908 may comprise, for example, a display and/or a printer.

Storage device 910 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “computer readable medium”, “memory”, “storage” or a “storage medium”.

Storage device 910 stores one or more programs for controlling processor 902. The programs comprise program instructions that contain processor-executable process steps of the wallet server computer 900, including, in some cases, process steps that constitute processes provided in accordance with principles of the processes presented herein.

The programs may include a consumer registration application 912 that manages a process wherein consumers register themselves and their consumer mobile devices and proximity readers for the one-tap account addition one-tap checkout services, as described herein. In some embodiments, the consumer registration application may allow consumers to register with the wallet server computer 308 by accessing, for example via their tablet computer or laptop computer or personal computer, a suitable web page hosted by the wallet server computer. The information obtained from the consumer during the registration process may include the consumer's name, residence address, email address, one or more primary payment account numbers (PANs), a mobile telephone number (or other mobile identifier), consumer device information such as a serial number and/or an IP address, and/or proximity reader information of a proximity reader associated with the consumer device. In some embodiments, the programs may also include a merchant one-tap registration application 914 that manages a process by which merchants register with a wallet server in order to offer the one-tap checkout service to consumers. In some implementations, merchants register by accessing a merchant registration web page from a wallet server computer website that includes a merchant interface for providing required information.

The storage device 910 may also store a device eligibility application 916 for use by the wallet server to determine whether or not a particular consumer device is capable of reading proximity devices (i.e., is NFC capable), and a contactless device authentication application 918. In addition, one or more databases 920 may be maintained by the wallet server computer 900 on the storage device 910. Among these databases may be, for example, a consumer registration information database, a merchant registration information database, and the like.

The application programs of the wallet server computer 900, as described above, may be combined in some embodiments, as convenient, into one, two or more application programs. Moreover, the storage device 910 may store other programs or applications, such as one or more operating systems, device drivers, database management software, web hosting software, business intelligence software (for example, to determine analytics which may be useful to merchants), and the like.

Accordingly, through use of the one-tap account addition and one-tap checkout services system, consumers can more easily and conveniently add proximity payment accounts to their electronic wallets and can more easily and quickly checkout from an online merchant's website. Merchants can utilize the system to facilitate consumer checkout, which enhances their website and makes it more attractive for consumers to shop at their online store. Furthermore, merchants who offer the one-tap checkout feature are provided with additional levels of security regarding consumer information and payment because the consumer's device is authenticated and the contactless card is verified before any of the consumer's data is pre-populated into the checkout fields of the merchant's website.

As the term “payment transaction” is used herein and in the appended claims, it should be understood to include the types of transactions commonly referred to as “purchase transactions”, which may be in connection with eCommerce transactions that may involve payment card accounts and/or payment card systems.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a wallet server computer from a consumer device, a request to enable a one-tap account addition feature;
receiving consumer registration data and consumer payment account data;
uploading, by the wallet server computer, consumer device data associated with the consumer device;
uploading reader device data of a reader device associated with the consumer device;
determining that the reader device is near-field communication capable;
storing the consumer registration data, consumer payment account data, and the consumer device data in an electronic wallet associated with a consumer; and
enabling, by the wallet server computer, a one-tap add account addition feature for the consumer device.

2. The method of claim 1, further comprising:
transmitting, by the wallet server to the consumer device, an opt-in prompt for a one-tap checkout feature;
receiving a request to enable the one-tap checkout feature;
enabling the one-tap checkout feature; and
transmitting, by the wallet server to the consumer device, a one-tap checkout cookie for storing on the consumer device.

3. The method of claim 2, further comprising:
receiving, by the wallet server, a request for one-tap checkout;
determining that the one-tap checkout cookie is resident on the consumer device; and
transmitting, by the wallet server computer to a merchant device, at least one of consumer identification data, consumer payment account data, and shipping data to populate the merchant's checkout webpage.

4. The method of claim 1, further comprising:
receiving, by the wallet server computer, merchant registration data and a request to provide a one-tap checkout feature on the merchant's website; and
providing, by the wallet server, a one-tap checkout option for use by registered consumers shopping on the merchant's website.

5. The method of claim 1, wherein the consumer registration data comprises at least one of a name, an e-mail address, a billing address, and a mobile telephone number.

6. The method of claim 1, wherein the consumer device data comprises at least a consumer device serial number and a model number.

7. The method of claim 1, wherein the reader device data comprises reader device identification data.

8. A computer-readable medium storing non-transitory instructions configured to cause a processor to:
receive a request to enable a one-tap account addition feature for a consumer device;
receive consumer registration data and consumer payment account data;
upload consumer device data associated with the consumer device;
upload reader device data of a reader device associated with the consumer device;
determine that the reader device is near-field communication capable;
store the consumer registration data, consumer payment account data, and the consumer device data in an electronic wallet associated with a consumer; and
enable a one-tap add account addition feature for the consumer device.

9. The computer-readable medium of claim 8, further comprising instructions configured to cause the processor to:
transmit an opt-in prompt for a one-tap checkout feature;
receive a request to enable the one-tap checkout feature;
enable the one-tap checkout feature; and
transmit a one-tap checkout cookie for storing on the consumer device.

10. The computer-readable medium of claim 9, further comprising instructions configured to cause the processor to:
receive a request for one-tap checkout;
determine that the one-tap checkout cookie is resident on the consumer device; and
transmit, to a merchant device, at least one of consumer identification data, consumer payment account data, and shipping data to populate the merchant's checkout webpage.

11. The computer-readable medium of claim 8, further comprising instructions configured to cause the processor to:
receive merchant registration data and a request to provide a one-tap checkout feature on the merchant's website; and
provide a one-tap checkout service option for use by registered consumers shopping on the merchant's website.

12. An apparatus comprising:
a processor;
a communications device operably connected to the processor; and
a storage device operably connected to the processor, the storage device storing non-transitory instructions configured to cause the processor to:
receive a request to enable a one-tap account addition feature for a consumer device;
receive consumer registration data and consumer payment account data;
upload consumer device data associated with the consumer device;
upload reader device data of a reader device associated with the consumer device;
determine that the reader device is near-field communication capable;
store the consumer registration data, consumer payment account data, and the consumer device data in an electronic wallet associated with a consumer; and
enable a one-tap add account addition feature for the consumer device.

13. A method, comprising:
receiving, by a wallet server computer, valid consumer login information from a registered consumer having an electronic wallet and using a consumer device;
determining, by the wallet server, that the consumer is registered for a one-tap account addition feature for the electronic wallet and that the consumer device is not registered;
uploading device data associated with the consumer device;
uploading reader device data of a reader device associated with the consumer device;
determining that the reader device is near-field communication capable;
enabling a one-tap account addition feature for the consumer device; and
storing, by the wallet server computer, the consumer device data with electronic wallet data associated with the registered consumer.

14. The method of claim 13, further comprising:
transmitting, by the wallet server to the consumer device, an opt-in prompt for a one-tap checkout feature;
receiving a request to enable the one-tap checkout feature; and
transmitting, by the wallet server to the consumer device, a one-tap checkout cookie for storing on the consumer device.

15. The method of claim 14, further comprising:
receiving, by the wallet server, a request for one-tap checkout;
determining that the one-tap checkout cookie is resident on the consumer device; and
transmitting, by the wallet server computer to a merchant device, at least one of consumer identification data, consumer payment account data, and shipping data to populate the merchant's checkout webpage.

16. A computer-readable medium storing non-transitory instructions configured to cause a processor to:
receive valid consumer login information from a registered consumer having an electronic wallet and using a consumer device;
determine that the consumer is registered for a one-tap account addition feature for the electronic wallet and that the consumer device is not registered;
upload device data associated with the consumer device;
upload reader device data of a reader device associated with the consumer device;
determine that the reader device is near-field communication capable;
enable a one-tap account addition feature for the consumer device; and
store the consumer device data with electronic wallet data associated with the registered consumer.

17. The computer-readable medium of claim 16, further comprising instructions configured to cause the processor to:
transmit an opt-in prompt for a one-tap checkout feature to the consumer device;
receive a request to enable the one-tap checkout feature; and
transmit a one-tap checkout cookie for storing on the consumer device.

18. The computer-readable medium of claim 17, further comprising instructions configured to cause the processor to:
receive a request for one-tap checkout;
determine that the one-tap checkout cookie is resident on the consumer device; and
transmit to a merchant device at least one of consumer identification data, consumer payment account data, and shipping data to populate the merchant's checkout webpage.

19. A method comprising:
receiving, by a wallet server computer, consumer sign-in data of a consumer;
authenticating the consumer and transmitting, by the wallet server, a consumer device authentication request to a device authentication server computer;
receiving, by the wallet server computer, a consumer device authentication confirmation, a consumer device identifier and a reader device capability indication;
providing, by the wallet server to the consumer device, a webpage including a tap-to-add payment account option for selection;
transmitting, in response to receiving an indication that the consumer selected the option, a request to the device authentication server to push a tap request to a reader device associated with the consumer device;
receiving, by the wallet server, payment account data read from a payment device by the reader device; and
storing, by the wallet server computer, the payment account data in an electronic wallet associated with the consumer.

20. The method of claim 19, further comprising, transmitting, by the wallet server to the consumer device, an account successfully added message.

21. The method of claim 19, wherein the device authentication server computer authenticates the consumer device by:
uploading device identification data from the consumer device; and
comparing the device identification data to consumer device registration data.

22. The method of claim 19, further comprising, prior to receiving a consumer device authentication confirmation:
receiving an indication that the consumer device is not authorized;
prompting, by the wallet server, the consumer to manually provide full consumer authentication data;
authenticating the consumer; and
adding the consumer device to a consumer device list of authorized consumer devices.

23. A computer-readable medium storing non-transitory instructions configured to cause a processor to:
receive consumer sign-in data of a consumer;
authenticate the consumer;
transmit a consumer device authentication request to a device authentication server computer;
receive a consumer device authentication confirmation, a consumer device identifier and a reader device capability indication;
provide to the consumer device, a webpage including a tap-to-add payment account option for selection;
transmit, in response to receiving an indication that the consumer selected the option, a request to the device authentication server to push a tap request to a reader device associated with the consumer device;
receive payment account data read from a payment device by the reader device; and
store the payment account data in an electronic wallet associated with the consumer.

24. The computer-readable medium of claim 23, further comprising instructions configured to cause the processor to transmit an account successfully added message to the consumer device.

25. The computer-readable medium of claim 23, further comprising, prior to the instructions for receiving the consumer device authentication confirmation, instructions configured to cause the processor to:
receive an indication that the consumer device is not authorized;
prompt the consumer to manually provide full consumer authentication data;
authenticate the consumer; and
add the consumer device to a consumer device list of authorized consumer devices.

26. An apparatus comprising:
a processor;
a communications device operably connected to the processor; and
a storage device operably connected to the processor, the storage device storing non-transitory instructions configured to cause the processor to:
receive consumer sign-in data of a consumer;
authenticate the consumer;
transmit a consumer device authentication request to a device authentication server computer;
receive a consumer device authentication confirmation, a consumer device identifier and a reader device capability indication;
provide to the consumer device, a webpage including a tap-to-add payment account option for selection;
transmit, in response to receiving an indication that the consumer selected the option, a request to the device authentication server to push a tap request to a reader device associated with the consumer device;
receive payment account data read from a payment device by the reader device; and
store the payment account data in an electronic wallet associated with the consumer.
